(19) United States
(12) Patent Application Publication
(10) Pub. No.: US 2026/0018812 A1
(43) Pub. Date: Jan. 15, 2026

(54) TERMINAL FITTING

(71) Applicant: SUMITOMO WIRING SYSTEMS, LTD., Mie (JP)

(72) Inventor: Kohei TAKAGI, Mie (JP)

(21) Appl. No.: 18/880,847

(22) PCT Filed: Jun. 20, 2023
(86) PCT No.: PCT/JP2023/022768

§ 371 Date: Jan. 3, 2025

(30) Foreign Application Priority Data
Jul. 11, 2022 (JP) 2022-111067

(51) Int. Cl. H01R 11/16

(52) U.S. Cl. CPC H01R 11/16

(57) ABSTRACT

A terminal fitting (10, 10A, 10B) is plate-shaped and is bent in a plate width direction. The terminal fitting (10, 10A, 10B) includes: a bent portion (11); a first connection portion (12) extending from the bent portion (11) in a first direction; a second connection portion (13) extending from the bent portion (11) in a second direction that intersects the first direction; a press portion (31) that protrudes from an end of the bent portion (11) on a second connection portion (13) side in the plate thickness direction of the bent portion (11), and has plate surfaces respectively facing the first direction and a direction opposite to the first direction; and a deformation restricting portion (32) that protrudes from the press portion (31) in the first direction, and faces an engaging portion (25) located on a bent portion (11) side.

### TECHNICAL FIELD

The present disclosure relates to a terminal fitting.

### BACKGROUND

The terminal fitting according to Patent Document 1 is a metal plate material that has an L shape as a whole, and includes a bent portion, a terminal box portion extending from the bent portion in a first direction, and a wire connection portion extending from the bent portion in a second direction that intersects the first direction. This terminal fitting has a shape such that the bent portion is bent in a plate thickness direction.

In contrast, as shown in FIG. 13, it is also possible to employ a terminal fitting 3 in which a bent portion 2 is bent in a plate width direction. This terminal fitting 3 includes a pair of first side walls 5 protruding from two ends of the bent portion 2 on a terminal box portion 4 side, and a pair of second side walls 7 protruding from two ends of the bent portion 2 on a wire connection portion 6 side. The first side walls 5 and the second side walls 7 are separated at inner and outer corners 8 of the bent portion 2 for the reasons of molding. Here, for example, if a load is applied to the wire connection portion 6 from above, the terminal fitting 3 may bend along a virtual line 9 connecting the inner and outer corners 8 of the bent portion 2. Accordingly, it is desirable to reinforce the bent portion 2. The terminal fittings disclosed in Patent Documents 2 to 7 each have a projecting piece structure in the surroundings of the opening of the terminal box portion. For example, it is conceivable to apply such a projecting piece structure to the terminal fitting 3 shown in FIG. 13 to reinforce the bent portion 2.

### PRIOR ART DOCUMENT

### Patent Document

Patent Document 1: JP 2017-004841 A
Patent Document 2: JP 2012-227000 A
Patent Document 3: JP 2008-282807 A
Patent Document 4: JP 2007-123265 A
Patent Document 5: JP 2001-266989 A
Patent Document 6: JP H11-345645 A
Patent Document 7: JP H11-233181 A

### SUMMARY OF THE INVENTION

### Problems to be Solved

However, even if any one of the projecting piece structures of Patent Documents 2 to 7 is directly applied to the terminal fitting 3 shown in FIG. 13, it is difficult to sufficiently reinforce the bent portion 2. There is also a concern that the addition of the projecting piece structure to the terminal fitting 3 will make the structure more complex.

Accordingly, it is an object of the present disclosure to provide a terminal fitting that can avoid complication of the structure and prevent deformation of a bent portion.

### Means to Solve the Problem

The terminal fitting according to the present disclosure relates to a terminal fitting that is plate-shaped and is bent in a plate width direction, the terminal fitting including: a bent portion located at a bent position; a first connection portion extending from the bent portion in a first direction; a second connection portion extending from the bent portion in a second direction that intersects the first direction; a press portion that protrudes from an end of the bent portion on a second connection portion side in a plate thickness direction of the bent portion, and has plate surfaces respectively facing in the first direction and a direction opposite to the first direction; and a deformation restricting portion that protrudes from the press portion in the first direction, and faces an engaging portion located on a bent portion side.

### Effect of the Invention

According to the present disclosure, it is possible to provide a terminal fitting that can avoid the complexity of the structure and prevent deformation of a bent portion.

### BRIEF DESCRIPTION OF THE DRAWINGS

FIG. 1 shows a terminal fitting connected to a wire in a plan view, and a housing into which this terminal fitting is to be assembled in a plan cross-sectional view, side by side, according to Embodiment 1.

FIG. 2 shows a plan view of the terminal fitting of Embodiment 1.

FIG. 3 is an enlarged back view showing a main part of the terminal fitting of Embodiment 1.

FIG. 4 is an enlarged perspective view showing the main part of the terminal fitting of Embodiment 1 as viewed from a position above a second connection portion side.

FIG. 5 is an enlarged perspective view showing the main part of the terminal fitting of Embodiment 1 as viewed from a position above a side different from that in FIG. 4.

FIG. 6 shows a plan view of a terminal fitting of Embodiment 2.

FIG. 7 is an enlarged cross-sectional view of a main portion taken along a line A-A in FIG. 6.

FIG. 8 is an enlarged perspective view showing the main part of the terminal fitting of Embodiment 2 as viewed from a position above a second connection portion side.

FIG. 9 is an enlarged perspective view showing the main part of the terminal fitting of Embodiment 2 as viewed from below.

FIG. 10 shows a plan view of a terminal fitting of Embodiment 3.

FIG. 11 is an enlarged perspective view showing a main part of the terminal fitting of Embodiment 3 as viewed from a position above a second connection portion side.

FIG. 12 is an enlarged perspective view showing the main part of the terminal fitting of Embodiment 3 as viewed from below.

FIG. 13 is a partially broken plan view of a portion including a bent portion of a terminal fitting of a background technology.

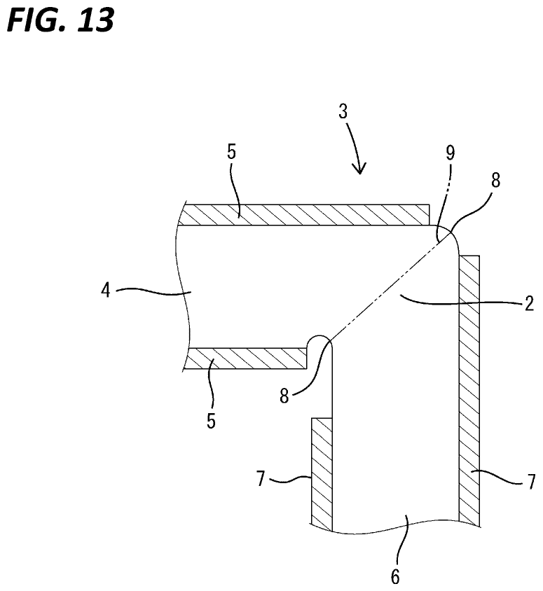

### DETAILED DESCRIPTION TO EXECUTE THE INVENTION

### Description of Embodiments of the Present Disclosure

Embodiments of the present disclosure will be first listed and described.
(1) The terminal fitting of the present disclosure relates to a terminal fitting that is plate-shaped and is bent in a plate width direction, the terminal fitting including: a bent portion located at a bent position; a first connection portion extending from the bent portion in a first direction; a second connection portion extending from the bent portion in a second direction that intersects the first direction; a press portion that protrudes from an end of the bent portion on a second connection portion side in a plate thickness direction of the bent portion, and has plate surfaces respectively facing in the first direction and a direction opposite to the first direction; and a deformation restricting portion that protrudes from the press portion in the first direction, and faces an engaging portion located on a bent portion side.

According to this configuration, if a load is applied to the second connection portion, the deformation restricting portion will abut against the engaging portion on the bent portion side, making it possible to prevent the bent portion from deforming. Also, an operator can press the press portion in the first direction to assemble the terminal fitting into an assembly target such as the housing.

Specifically, since the deformation restricting portion has a shape of protruding from the press portion in the first direction, and the deformation restricting portion and the press portion are compactly integrated as a projecting piece structure, it is possible to avoid the complexity of the structure.
(2) Preferably, the engaging portion includes: a standing portion protruding from an end of the bent portion on a first connection portion side in the plate thickness direction of the bent portion; a ceiling portion extending in the second direction from a leading end of the standing portion in a protruding direction; and a suspended portion protruding from a leading end of the ceiling portion in the second direction toward the bent portion, and the engaging portion and the bent portion form a tubular shape.

According to this configuration, since the engaging portion and the bent portion form a tubular structure, it is possible to enhance the rigidity of the bent portion. Specifically, if a load is applied to the second connection portion in the plate thickness direction, the leading end of the suspended portion in the protruding direction will abut against a plate surface of the bent portion, making it possible to prevent the bent portion from deforming.
(3) Preferably, the first connection portion includes a tubular box portion that is open in the first direction, and the engaging portion is continuous with the box portion.

According to this configuration, it is possible to enhance the rigidity of the engaging portion, and avoid the structure from becoming more complex.
(4) Preferably, the first connection portion includes a tubular box portion that is open in the first direction, and the engaging portion is separated from the box portion.

According to this configuration, the engaging portion can be formed without any restrictions in the shape of the box portion, and thus the degree of freedom in the shape of the engaging portion can be increased. For example, an engaging portion that is shorter in height than the box portion can be employed to improve the yield.
(5) Preferably, the deformation restricting portion faces the engaging portion in the plate thickness direction of the bent portion.

According to this configuration, if a load is applied to the second connection portion in the plate thickness direction, the deformation restricting portion will abut against the engaging portion, making it possible to prevent the bent portion from deforming.
(6) Preferably, the suspended portion includes a protrusion protruding in a direction opposite to the first direction, and the protrusion is disposed in an inner space formed between the press portion, the deformation restricting portion, and the bent portion.

According to this configuration, even if a load is applied to second connection portion from any one of two sides in the plate thickness direction, the protrusion disposed in the inner space can abut against the deformation restricting portion or the bent portion, thus making it possible to further prevent the deformation of the bent portion. Note that not only the entire protrusion can be disposed in the inner space, but also only a part of the protrusion can be disposed.
(7) Preferably, the deformation restricting portion overlaps with an outer surface of the ceiling portion.

According to this configuration, if a load is applied to the second connection portion in the plate thickness direction, the deformation of the ceiling portion can be prevented by the deformation restricting portion. Specifically, because the deformation restricting portion can abut against the ceiling portion over a long area in the second direction, the engagement allowance between the ceiling portion and the deformation restricting portion can be sufficiently secured. Also, by employing a ceiling portion that is short in height, it is possible to improve the yield.
(8) Preferably, the deformation restricting portion faces, inside the engaging portion, at least one of inner surfaces of the suspended portion and the standing portion.

According to this configuration, if a load is applied to the second connection portion in the plate width direction, the deformation restricting portion will abut against the inner surface of the suspended portion or the standing portion, making it possible to prevent the deformation of the bent portion. Specifically, since the engaging portion does not need to have a dedicated structure for engagement, the complexity of the structure can be further avoided.

### DETAILS OF EMBODIMENTS OF THE PRESENT DISCLOSURE

The following will describe specific examples of the present disclosure with reference to the drawings. Note that the present invention is not limited to the examples but is defined by the claims, and all modifications within the meaning and scope equivalent to the claims are intended to be included.

### Embodiment 1

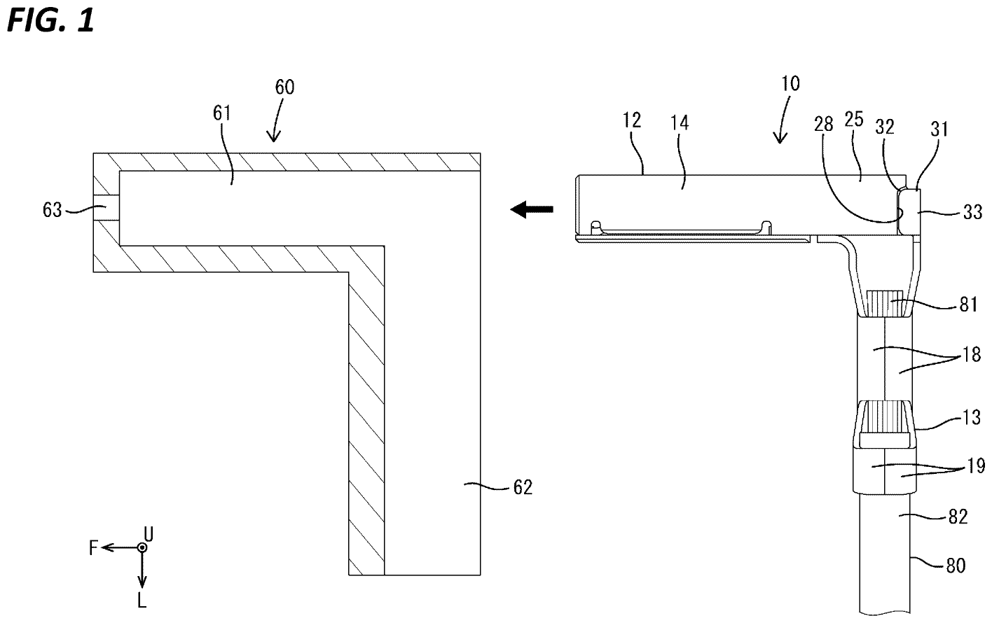

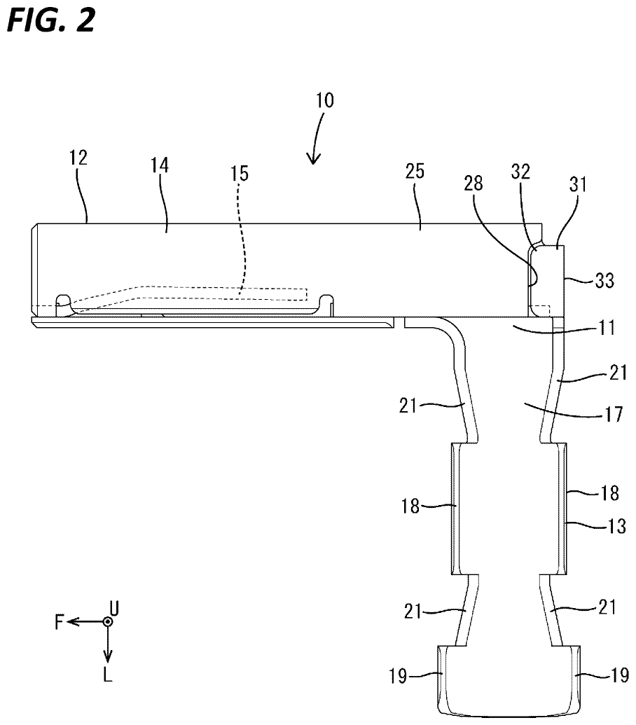

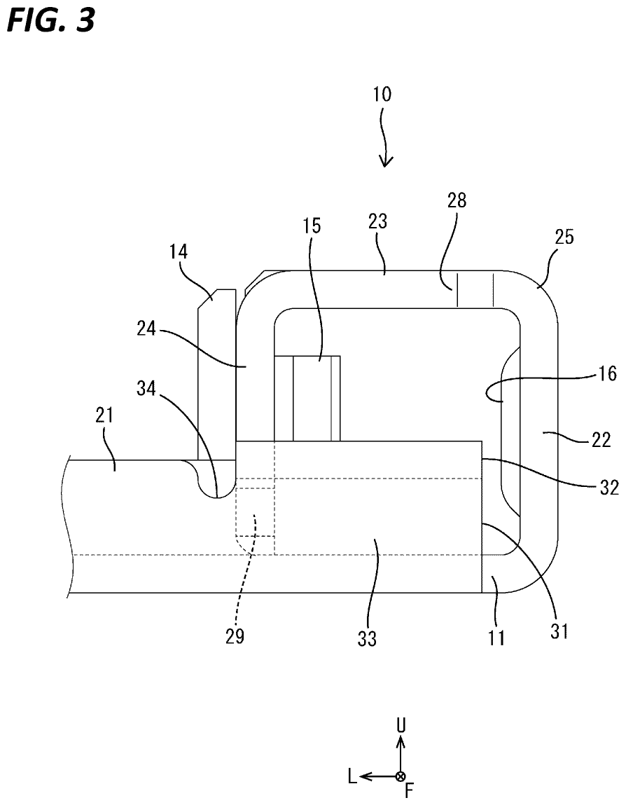

The terminal fitting 10 of Embodiment 1 of the present disclosure is formed in one piece by, for example, bending a conductive metal plate. As shown in FIG. 1, this terminal fitting 10 is connected to a terminal of the wire 80 and is to be assembled into a housing 60, serving as an assembly target. Note that, in the following description, the front side in the paper thickness direction in FIGS. 1 and 2 and the upper side in FIGS. 3, 4, and 5 are defined as the upper side with respect to an up-down direction. The left side in FIGS. 1 and 2 is defined as the front side with respect to a front-back direction. The left side in FIG. 3 is defined as the left side with respect to a left-right direction. In each figure, arrows U, F, and L indicate upward, forward, and leftward directions, respectively. Note that the forward direction is sometimes referred to as a first direction. The leftward direction is sometimes referred to as a second direction. These directions do not necessarily correspond to the directions in a state in which the terminal fitting 10 is assembled into the housing 60 and this assembly is installed in a vehicle or the like. Also, the bases of these directions are also applied to Embodiment 2 and Embodiment 3, which are described below.

### (Housing)

The housing 60 is made of synthetic resin and is L-shaped in a plan view, although details thereof are not shown. As shown in FIG. 1, the housing 60 includes a first cavity 61 extending in the front-back direction and a second cavity 62 extending in the left-right direction while being in communication with the rear end of the first cavity 61. The first cavity 61 opens in the front end surface of the housing 60 via a tab insertion opening 63.

The second cavity 62 opens in the rear end surface and the left end surface of the housing 60. The terminal fitting 10 is inserted into the first cavity 61 and the second cavity 62 from behind, and is assembled into the housing 60. After the assembling of the terminal fitting 10, a not-shown cover is fitted to the housing 60 from behind. The rear end opening of the second cavity 62 is closed by the cover. Note that, before assembling the terminal fitting 10 into the housing 60, a not-shown ferrite core is mounted to the terminal fitting 10.

### (Terminal Fitting)

As shown in FIG. 2, the terminal fitting 10 is L-shaped in a plan view, and is bent in the plate width direction. The terminal fitting 10 includes a bent portion 11 located at a bent position midway in a length direction, a first connection portion 12 extending from the bent portion 11 in the first direction, and a second connection portion 13 extending from the bent portion 11 in the second direction. The bent portion 11 has a rectangular flat plate shape in a plan view, and is flat along the front-back and left-right directions.

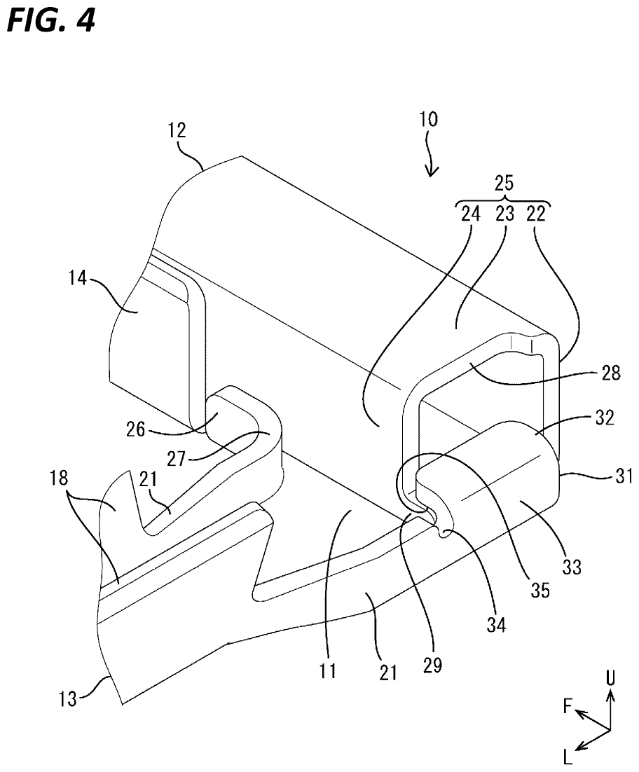

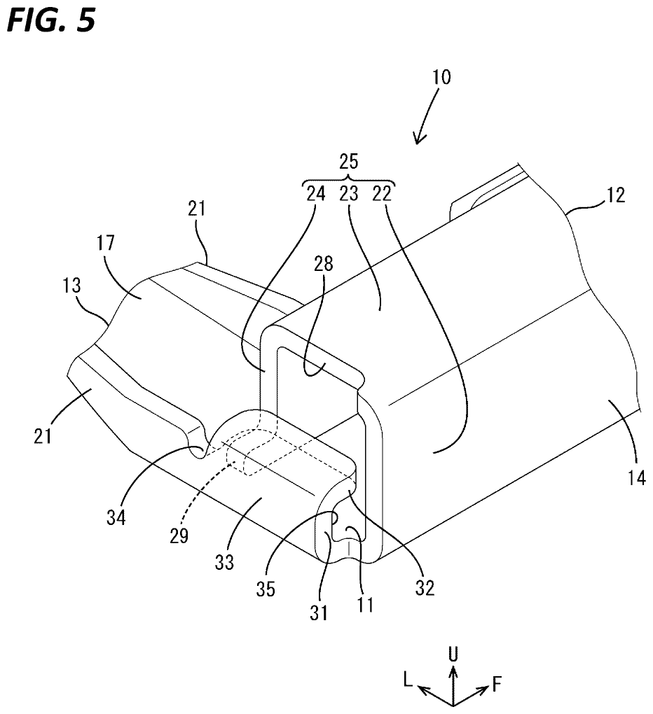

As shown in FIGS. 4 and 5, the first connection portion 12 includes a square tubular box portion 14. The box portion 14 opens in the front-rear direction. However, the rear open face of the box portion 14 is partially covered by a press portion 31 and a deformation restricting portion 32, which will be described later. The lower-side wall of the box portion 14 is seamlessly coupled to the front end of the bent portion 11. As shown in FIG. 2, an elastic contact piece 15 is disposed inside the box portion 14. The elastic contact piece 15 has a mountain shape extending in the front-back direction and is elastically deformable with its front end coupled to the left-side wall (specifically, the inner wall of left-side double walls, namely, inner and outer walls) of the box portion 14 as a fulcrum. As shown in FIG. 3, the right-side wall of the box portion 14 has a bead 16 that is curved toward the elastic contact piece 15.

The first connection portion 12 is inserted into the first cavity 61 from behind the housing 60. If the housing 60 engages with a not-shown counterpart housing, a not-shown tab-shaped counterpart terminal fitting fitted to the counterpart housing is inserted into the box portion 14 via the tab insertion opening 63. The counterpart terminal fitting is interposed between the elastic contact piece 15 and the bead 16, and is electrically connected to the terminal fitting 10.

As shown in FIG. 2, the second connection portion 13 includes a base 17 seamlessly coupled to the left end of the bent portion 11, a pair of wire barrel pieces 18 that rise from the front and rear ends of the base 17 so as to face each other, and a pair of insulation barrel pieces 19 that are located at positions to the left of the wire barrel pieces 18 and rise from the front and rear ends of the base 17 so as to face each other. As shown in FIG. 1, the wire barrel pieces 18 are bent using a not-shown crimping jig with a core wire portion 81 of the wire 80 interposed between the wire barrel pieces 18 and the base 17, and are electrically connected to the wire 80. The insulation barrel pieces 19 are also bent using a not-shown crimping jig with an insulation coating 82 of the wire 80 interposed between the insulation barrel pieces 19 and the base 17, and are mechanically connected to the wire 80.

As shown in FIG. 2, the second connection portion 13 includes pairs of side walls 21 that are located, with respect to the left and right direction, at a position between the insulation barrel pieces 19 and the wire barrel pieces 18, and a position to the right of the wire barrel pieces 18, respectively, and rise from the front and rear ends of the base 17 so as to face each other. The rising dimension of the side walls 21 is smaller than the rising dimensions of the wire barrel pieces 18 and the insulation barrel pieces 19.

As shown in FIG. 3, the terminal fitting 10 includes a standing portion 22 projecting upward from the right end of the bent portion 11, a ceiling portion 23 extending in the second direction from the upper end of the standing portion 22, and a suspended portion 24 projecting downward from the left end of the ceiling portion 23. The standing portion 22, the ceiling portion 23, and the suspended portion 24 constitute an engaging portion 25 capable of engaging with the deformation restricting portion 32, which will be described later.

As shown in FIG. 5, the standing portion 22 is a vertical wall extending along the front-back and up-down direction directions, and the front end of the standing portion 22 is seamlessly connected to the right-side wall of the box portion 14. The ceiling portion 23 is a horizontal wall extending along the front-back and left-right directions, with the front end seamlessly connected to the upper-side wall of the box portion 14. Also, the ceiling portion 23 is bridged between the upper ends of the standing portion 22 and the suspended portion 24, and is disposed in parallel to and facing the bent portion 11.

As shown in FIG. 4, the suspended portion 24 is a vertical wall extending along the front-back and up-down directions, and the front end of the suspended portion 24 is seamlessly coupled to the left-side wall (specifically, the inner wall of left-side double walls, namely, inner and outer walls) of the box portion 14. Also, the suspended portion 24 is disposed in parallel to and facing the standing portion 22. The lower end of the suspended portion 24 is disposed in close proximity to the upper surface of the bent portion 11 and extends in the front-rear direction.

The outer surface (left-side surface) of the box portion 14 continuous with the suspended portion 24 is partially covered by an extended side wall 26. The extended side wall 26 is coupled to the side wall 21 of the second connection portion 13 via a curved wall 27 formed at the inside corner of the bent portion 11.

As shown in FIG. 4, the rear end of the engaging portion 25 has a recess 28 in the form of a cutout starting from the right-side end of the ceiling portion 23 to the lower-side end of the suspended portion 24. The lower rear end of the suspended portion 24 is configured as a protrusion 29 protruding rearwardly relative to the recess 28. The lower surface of the protrusion 29 is a part of the lower end of the suspended portion 24, and is disposed in the front-rear direction. The upper surface of the protrusion 29 is a part of the inner surface of the recess 28, and is also disposed in the front-rear direction.

As shown in FIG. 5, the terminal fitting 10 also includes the press portion 31 protruding upward from the rear end of the bent portion 11, and the deformation restricting portion 32 protruding in the first direction from the upper end of the press portion 31. The press portion 31 is a standing wall extending along the left-right and up-down directions with the left end thereof coupled to the side wall 21 of the second connection portion 13. The right end of the press portion 31 is located at a position away from and to the left of the standing portion 22 with respect to the left-right direction. Of the front and rear surfaces, which are plate surfaces of the press portion 31, the front surface is disposed facing in the first direction and the rear surface is disposed facing in a direction opposite to the first direction. The rear surface of the press portion 31 is seamlessly continuous with the rear surface of the side wall 21, and is configured as a press surface 33 to be pressed when the first connection portion 12 is inserted into the first cavity 61.

The deformation restricting portion 32 is bent forward from the upper end of the press portion 31, and has the same width as the press portion 31 with respect to the left-right direction. A cutout 34 is formed between the left upper end of the press portion 31 and the right upper end of the side wall 21.

In the case of Embodiment 1, the forward protruding dimension of the deformation restricting portion 32 is set to be smaller than the protruding dimension of the protrusion 29. However, in contrast to Embodiment 1, the forward protruding dimension of the deformation restricting portion 32 may be set to be larger than the protruding dimension of the protrusion 29. Due to the deformation restricting portion 32 and the protrusion 29 having different protruding dimensions, it is possible to improve the formability. Furthermore, the forward protruding dimension of the deformation restricting portion 32 may be equal to the protruding dimension of the protrusion 29, thereby making it possible to improve the strength of the bent portion 11 and the engaging portion 25.

The deformation restricting portion 32 faces the upper surface of the bent portion 11, and forms an inner space 35 open in the first direction between the bent portion 11 and the press portion 31, as shown in FIG. 4. At the left end of this inner space 35, the protrusion 29 is inserted from the front and is positioned. Here, the upper surface of the protrusion 29 is disposed facing the lower surface of the left end of the deformation restricting portion 32 so as to be contactable (including contact) therewith. The lower surface of the protrusion 29 is disposed facing the upper surface of the bent portion 11 so as to be contactable therewith.

### Effects

As a result of a not-shown finger or the like being applied to the press surface 33 of the press portion 31, the press portion 31 is pressed from behind and the first connection portion 12 is inserted into the first cavity 61 (see FIG. 1). At the same time, the second connection portion 13 is also inserted into the second cavity 62, so the terminal fitting 10 is assembled into the housing 60. Then, a not-shown cover is fitted to the housing 60. With this, the terminal fitting 10 is retained and housed in the housing 60.

Meanwhile, during the crimping process of the wire 80 or due to vibration, etc. of the crimped wire 80, a load (external force) may be applied to the second connection portion 13, and the applied load may propagate to the bent portion 11, resulting in a high stress in the bent portion 11.

If a load is applied to the second connection portion 13 from above (above in the plate thickness direction of the base 17), the left end of the deformation restricting portion 32 will abut against the upper surface of the protrusion 29, restricting the downward displacement (deformation) of the deformation restricting portion 32 and restricting the downward displacement of the bent portion 11 continuous with the deformation restricting portion 32 (see FIG. 4). Also, if a load is applied to the second connection portion 13 from below (below in the plate thickness direction of the base 17), the bent portion 11 will abut against the protrusion 29 and the lower end of the suspended portion 24, restricting the upward displacement of the bent portion 11. Furthermore, if a load is applied to the second connection portion 13 from behind (behind in the plate width direction of the base 17), the left end of the deformation restricting portion 32 will abut against the inner surface of the recess 28 (the rear end of the suspended portion 24) and the extended side wall 26 will abut against the outer surface of the box portion 14 continuous with the suspended portion 24, restricting the forward displacement of the second connection portion 13 as well.

Thus, according to Embodiment 1, the terminal fitting 10 can be assembled into the housing 60 by pressing the press portion 31 from behind. If a load is applied to the second connection portion 13, the deformation restricting portion 32 will abut against the protrusion 29 and the like of the engaging portion 25, making it possible to prevent the bent portion 11 from deforming. Specifically, in Embodiment 1, since the deformation restricting portion 32 is continuous from the press portion 31, and the deformation restricting portion 32 and the press portion 31 form an integrated projecting piece structure, it is possible to realize a simplified configuration compared to the case where the deformation restricting portion 32 and the press portion 31 are formed separately.

Also, since the engaging portion 25 and the bent portion 11 form the tubular structure, it is possible to enhance the rigidity of the bent portion 11 itself. Moreover, since the engaging portion 25 is continuous with the box portion 14 of the first connection portion 12, it is also possible to enhance the rigidity of the engaging portion 25 itself.

Furthermore, the protrusion 29 is disposed in the inner space 35 formed between the press portion 31, the deformation restricting portion 32, and the bent portion 11, so that even if a load is applied to the second connection portion 13 from any one of two sides in the plate thickness direction, the protrusion 29 disposed in the inner space 35 can abut against the deformation restricting portion 32 or the bent portion 11, thus making it possible to further prevent the deformation of the bent portion 11.

### Embodiment 2

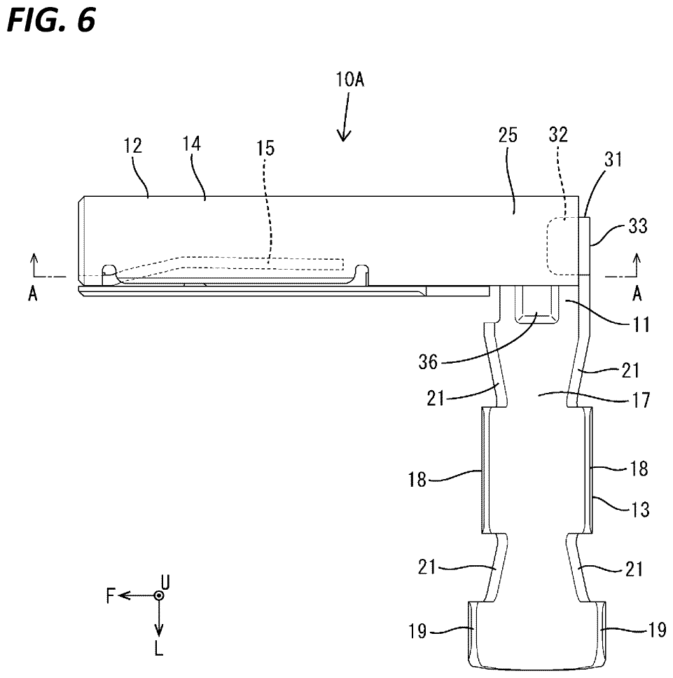

As shown in FIGS. 6 to 9, a terminal fitting 10A according to Embodiment 2 of the present disclosure differs from the terminal fitting of Embodiment 1 in the shapes of the bent portion 11 and a surrounding area of the bent portion 11. Other configurations are the same as in Embodiment 1, and the same reference numerals are given to the same or corresponding configurations as those in Embodiment 1, and redundant descriptions are omitted.

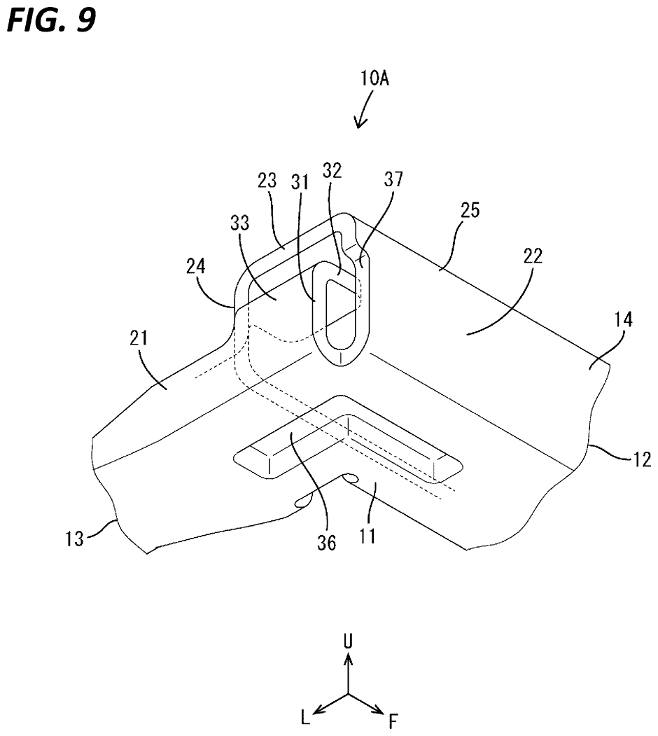

As shown in FIG. 9, the bent portion 11 includes, in the center thereof in the plate width direction, a receiving portion 36 having a shape such that it is curved upward by press work. The receiving portion 36 is L-shaped when viewed in a bottom view, and includes a portion extending in the front-rear direction and a portion extending in the left-right direction. The upper surface of the receiving portion 36 is flat along the front-back and left-right directions.

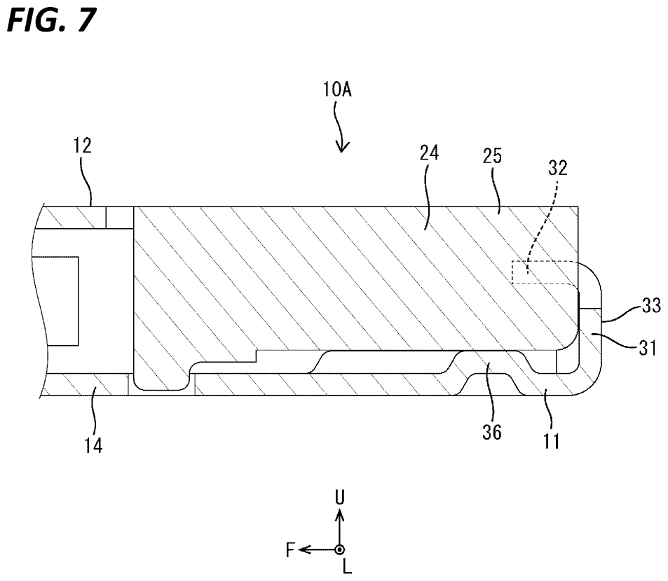

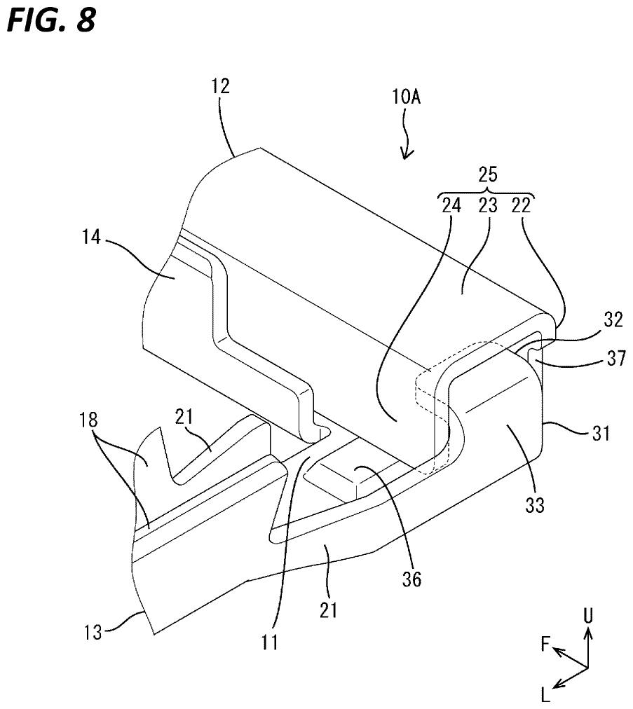

Above the bent portion 11, the engaging portion 25 constituted by the standing portion 22, the ceiling portion 23, and the suspended portion 24 is formed, as in Embodiment 1. As shown in FIG. 7, the lower end of the suspended portion 24 faces the upper surface of the receiving portion 36 so as to be contactable therewith along the front-back direction. As shown in FIGS. 8 and 9, a recess 37 in the form of a cutout is formed at the rear end of the standing portion 22 except for the upper end of the standing portion 22. Unlike in Embodiment 1, the engaging portion 25 does not have either a recess 28 or a protrusion 29.

As in Embodiment 1, the terminal fitting 10A includes the press portion 31 protruding upward from the rear end of the bent portion 11, and the deformation restricting portion 32 protruding from the upper end of the press portion 31 in the first direction. The up-down dimension of the press portion 31 (protruding dimension from the bent portion 11) is set to be larger than that of Embodiment 1. The upper end position of the press portion 31 (height position of the deformation restricting portion 32) corresponds to the upper end position of the recess 37. In the case of Embodiment 2, since the upper end position of the press portion 31 is high, a structure corresponding to the cutout 34 of Embodiment 1 is not formed between the press portion 31 and the side walls 21, and the right ends of the side walls 21 are coupled to the press portion 31 in one piece.

The front-rear dimension of the deformation restricting portion 32 (protruding dimension from the press portion 31) is set to be larger than that of Embodiment 1. The deformation restricting portion 32 is disposed while being inserted into the inner space of the engaging portion 25 surrounded by the standing portion 22, the ceiling portion 23, and the suspended portion 24. As shown in FIG. 8, the left end of the deformation restricting portion 32 faces the inner surface (right-side surface) of an upper portion of the suspended portion 24 so as to be contactable therewith. The right end of the deformation restricting portion 32 faces the inner surface of an upper portion of the standing portion 22 at an interval.

When assembling the terminal fitting 10A into the housing 60, the press surface 33 of the press portion 31 is pressed from behind, as in Embodiment 1. In the case of Embodiment 2, the area of the press surface 33 is wider than that of Embodiment 1. Therefore, it is possible to stabilize the assembly operation of the terminal fitting 10A.

If a load is applied to the second connection portion 13 from forward (forward in the plate width direction of the base 17), the left end of the deformation restricting portion 32 will abut against the inner surface of the upper portion of the suspended portion 24, restricting the displacement of the deformation restricting portion 32 in the second direction and to the rear, and restricting the displacement of the bent portion 11 continuous with the deformation restricting portion 32 in the second direction and to the rear.

Thus, according to Embodiment 2, if a load is applied to the second connection portion 13 from forward, the deformation restricting portion 32 will abut against the inner surface of the suspended portion 24, making it possible to prevent the bent portion 11 from deforming. Specifically, since the engaging portion 25 does not need to have a dedicated structure for engagement, the complexity of the structure can be further avoided. Furthermore, according to Embodiment 2, if a load is applied to the second connection portion 13 from below (below in the plate thickness direction of the base 17), the receiving portion 36 will abut against the lower end of the suspended portion 24, restricting the upward displacement of the bent portion 11.

### Embodiment 3

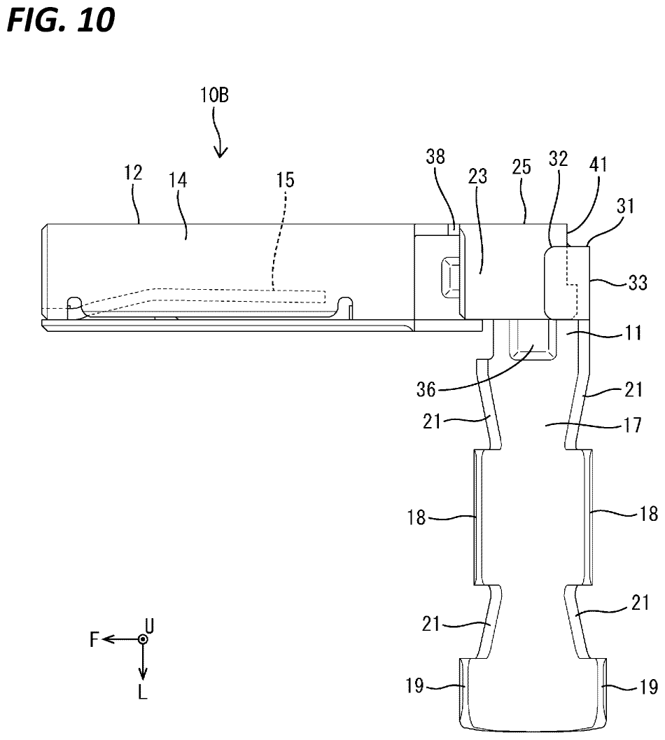

As shown in FIGS. 10 to 12, a terminal fitting 10B according to Embodiment 3 of the present disclosure differs from the terminal fitting of Embodiment 1 in the shapes of the bent portion 11 and a surrounding area of the bent portion 11. Other configurations are the same as in Embodiment 1, and the same reference numerals are given to the same or corresponding configurations as those in Embodiment 1, and redundant descriptions are omitted.

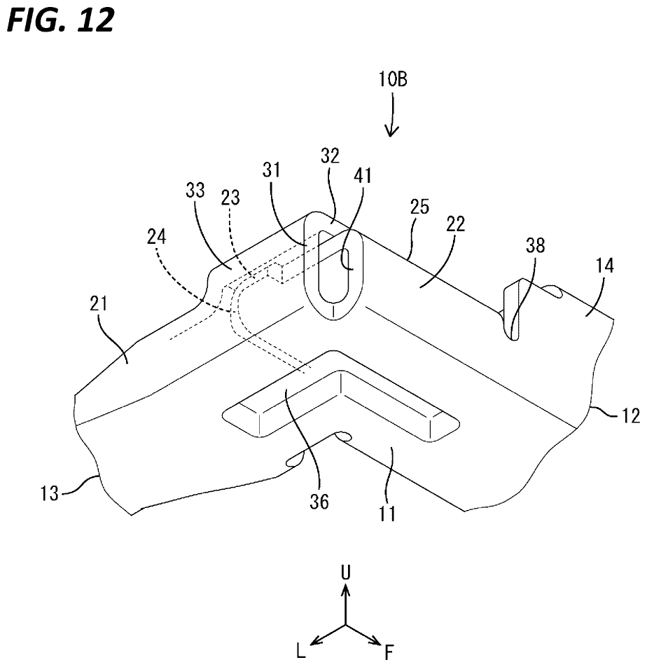

As shown in FIG. 12, the bent portion 11 includes the receiving portion 36 that is curved upward and is L-shaped in a bottom view, as in Embodiment 2. Above the bent portion 11, the engaging portion 25 constituted by the standing portion 22, the ceiling portion 23, and the suspended portion 24 is formed, as in Embodiment 1. The up-down dimension of the standing portion 22 (protruding dimension from the bent portion 11) and the up-down dimension of the suspended portion 24 (protruding dimension from the ceiling portion 23) are set to be smaller than those of Embodiment 1.

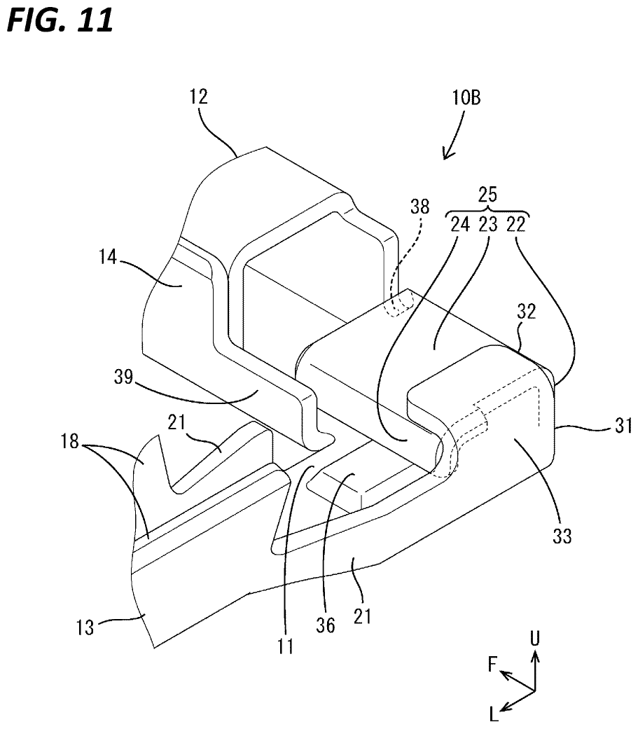

The engaging portion 25 is separated from the box portion 14 of the first connection portion 12. As shown in FIG. 11, the front ends of the ceiling portion 23 and the suspended portion 24 are located at positions rearward of the box portion 14. As shown in FIG. 12, a notch 38 is formed between the front end of an upper portion of the standing portion 22 and the right-side wall of the box portion 14. As shown in FIG. 11, the outer surface (left-side surface) of a front portion of the suspended portion 24 faces a rear end extended portion 39 of the left-side wall (specifically, the outer wall of left-side double walls, namely, inner and outer walls) of the box portion 14 so as to be contactable therewith. The lower end of the suspended portion 24 faces the upper surface of the receiving portion 36 so as to be contactable therewith along the front-back direction.

As shown in FIG. 12, the rear end of the engaging portion 25 has a recess depression 41 in the form of a cutout starting from the left-side end of the ceiling portion 23 to the standing portion 22. Unlike in Embodiment 1, the engaging portion 25 does not have either a recess 28 or a protrusion 29.

As in Embodiment 1, the terminal fitting 10B includes the press portion 31 protruding upward from the rear end of the bent portion 11, and the deformation restricting portion 32 protruding in the first direction from the upper end of the press portion 31. The press portion 31 and the deformation restricting portion 32 are formed with the same width with respect to the left-right direction, with the left ends located at the same location as or in close proximity to the left-side surface of the engaging portion 25 (see FIG. 10) and the right ends located to the left of the right-side surface of the standing portion 22. A structure corresponding to the cutout 34 of Embodiment 1 is not formed between the press portion 31 and the side walls 21, and the right ends of the side walls 21 are coupled to the press portion 31 in one piece.

As shown in FIG. 11, the up-down dimension of the press portion 31 (protruding dimension from the bent portion 11) is set to be larger than the up-down dimension of the engaging portion 25. The front-rear dimension of the deformation restricting portion 32 (protruding dimension from the press portion 31) is set to be larger than that of Embodiment 1. The deformation restricting portion 32 is disposed so as to cover the rear upper surface of the ceiling portion 23 of the engaging portion 25, while facing the upper surface of the ceiling portion 23 so as to be contactable therewith in the left-right direction. In short, the deformation restricting portion 32 is arranged to overlap with the outer surface of the ceiling portion 23. At the rear end of the engaging portion 25, the press portion 31 faces the left-side end of the ceiling portion 23 and the suspended portion 24 so as to be contactable with them.

When assembling the terminal fitting 10B into the housing 60, the press surface 33 of the press portion 31 is pressed from behind, as in Embodiment 1.

If a load is applied to the second connection portion 13 from above (above in the plate thickness direction of the base 17), the deformation restricting portion 32 will abut against the upper surface (outer surface) of the ceiling portion 23, restricting the downward displacement of the deformation restricting portion 32 and also restricting the downward displacement of the bent portion 11 continuous with the deformation restricting portion 32. Specifically, in the case of Embodiment 3, because the deformation restricting portion 32 can abut against the ceiling portion 23 over the entire width of the deformation restricting portion 32 in the left-right direction, the engagement allowance between the ceiling portion 23 and the deformation restricting portion 32 can be sufficiently secured. In addition, since the engaging portion 25 is separated from the box portion 14, it is possible to form the engaging portion 25 without any restrictions in the shape of the box portion 14. In the case of Embodiment 3, since the engaging portion 25 is shorter in height than the box portion 14, it is possible to improve the yield.

Also, if a load is applied to the second connection portion 13 from behind (behind in the plate width direction of the base 17), the press portion 31 will abut against the rear end of the engaging portion 25, restricting the forward displacement of the press portion 31 and also restricting the forward displacement of the bent portion 11 continuous with the press portion 31. Moreover, if a load is applied to the second connection portion 13 from forward (forward in the plate width direction of the base), the suspended portion 24 will abut against the rear end extended portion 39 of the box portion 14, restricting the rearward displacement of the engaging portion 25 including the suspended portion 24 and also restricting the rearward displacement of the bent portion 11 continuous with the engaging portion 25. Furthermore, according to Embodiment 3, if a load is applied to the second restricting portion from below (below in the plate thickness direction of the base 17), the receiving portion 36 will abut against the lower end of the suspended portion 24, restricting the upward displacement of the bent portion 11.

### OTHER EMBODIMENTS OF PRESENT DISCLOSURE

Above-described Embodiments 1 to 3 disclosed herein are examples in all respects and should be construed as non-limiting.

In Embodiments 1 to 3, the forward direction is defined as the first direction and the leftward direction is defined as the second direction. In contrast thereto, in other embodiments, a direction other than the forward direction may be defined as the first direction, and a direction other than the leftward direction and intersecting with the first direction may be defined as the second direction.

In Embodiments 1 to 3, the first direction and the second direction are orthogonal to each other. In contrast thereto, in other embodiments, the first direction and the second direction do not need to be orthogonal to each other as long as they intersect with each other.

In Embodiments 1 to 3, the engaging portion is constituted by the standing portion, the ceiling portion, and the suspended portion. In contrast thereto, in other embodiments, the engaging portion does not need to include the suspended portion, and may have a structure in which the ceiling portion overlaps with the bent portion without any space therebetween, and the ceiling portion and the bent portion form a double wall.

In Embodiment 2, the left end of the deformation restricting portion is disposed, while facing the inner surface of the suspended portion so as to be contactable therewith. In contrast thereto, in other embodiments, the right end of the deformation restricting portion may be disposed, while facing the inner surface of the standing portion so as to be contactable therewith. Alternatively, the left and right ends of the deformation restricting portion may be disposed, while facing the inner surface of the suspended portion and the inner surface of the standing portion so as to be contactable with them.

### LIST OF REFERENCE NUMERALS

10, 10A, 10B Terminal fitting
11 Bent portion
12 First connection portion
13 Second connection portion
14 Box portion
15 Elastic contact piece
16 Bead
17 Base
18 Wire barrel piece
19 Insulation barrel piece
21 Side wall
22 Standing portion
23 Ceiling portion
24 Suspended portion
25 Engaging portion
26 Extended side wall
27 Curved wall
28 Recess
29 Protrusion
31 Press portion
32 Deformation restricting portion
33 Press surface
34 Cutout
35 Inner space
36 Receiving portion
37 Recess
38 Notch
39 Rear end extended portion
41 Recess depression
60 Housing
61 First cavity
62 Second cavity
63 Tab insertion opening
80 Wire
81 Core wire portion
82 Insulation coating
2 Bent portion of the prior art
3 Terminal fitting of the prior art
4 Terminal box portion of the prior art
5 First side wall of the prior art
6 Wire connection portion of the prior art
7 Second side wall of the prior art
8 Inner and outer corners of the prior art
9 Virtual line of the prior art

1. A terminal fitting that is plate-shaped and is bent in a plate width direction, the terminal fitting comprising:
a bent portion located at a bent position;
a first connection portion extending from the bent portion in a first direction;
a second connection portion extending from the bent portion in a second direction that intersects the first direction;
a press portion that protrudes from an end of the bent portion on a second connection portion side in a plate thickness direction of the bent portion, and has plate surfaces respectively facing in the first direction and a direction opposite to the first direction; and
a deformation restricting portion that protrudes from the press portion in the first direction, and faces an engaging portion located on a bent portion side.

2. The terminal fitting according to claim 1,
wherein the engaging portion includes:
a standing portion protruding from an end of the bent portion on a first connection portion side in the plate thickness direction of the bent portion;
a ceiling portion extending in the second direction from a leading end of the standing portion in a protruding direction; and
a suspended portion protruding from a leading end of the ceiling portion in the second direction toward the bent portion, and
the engaging portion and the bent portion form a tubular shape.

3. The terminal fitting according to claim 2,
wherein the first connection portion includes a tubular box portion that is open in the first direction, and the engaging portion is continuous with the box portion.

4. The terminal fitting according to claim 2,
wherein the first connection portion includes a tubular box portion that is open in the first direction, and the engaging portion is separated from the box portion.

5. The terminal fitting according to claim 2,
wherein the deformation restricting portion faces the engaging portion in the plate thickness direction of the bent portion.

6. The terminal fitting according to claim 5,
wherein the suspended portion includes a protrusion protruding in a direction opposite to the first direction, and
the protrusion is disposed in an inner space formed between the press portion, the deformation restricting portion, and the bent portion.

7. The terminal fitting according to claim 5,
wherein the deformation restricting portion overlaps with an outer surface of the ceiling portion.

8. The terminal fitting according to claim 2,
wherein the deformation restricting portion faces, inside the engaging portion, at least one of inner surfaces of the suspended portion and the standing portion.
